(19) United States
(12) Patent Application Publication
(10) Pub. No.: US 2005/0065238 A1
(43) Pub. Date: Mar. 24, 2005

(54) Encapsulated nanoparticles, products containing the same, and methods for using the same

(76) Inventor: John C. Lark, Columbus, GA (US)

Correspondence Address: WITHERS & KEYS, LLC, P. O. BOX 2049, MCDONOUGH, GA, 30253, US

(21) Appl. No.: 10/948,361

(22) Filed: Sep. 23, 2004

Related U.S. Application Data
(60) Provisional application No. 60/525,554, filed on Nov. 26, 2003.
(60) Provisional application No. 60/505,278, filed on Sep. 23, 2003.

(51) Int. Cl. C08K 9/10; D03D 15/00

(52) U.S. Cl. 523/210; 442/181; 442/327; 428/373

(57) ABSTRACT

Compositions containing encapsulated nanoparticles are disclosed. Methods for making and using the compositions are also disclosed.

### CROSS-REFERENCE TO RELATED APPLICATIONS

This patent application claims the benefit of priority to U.S. Provisional Application Ser. No. 60/525,554 filed on Nov. 26, 2003 and U.S. Provisional Application Ser. No. 60/505,278 filed on Sep. 23, 2003, the subject matter of both of which is incorporated herein in its entirety.

### FIELD OF THE INVENTION

The present invention relates to compositions containing encapsulated nanoparticles. The present invention further relates to methods for making and using the compositions, as well as, products containing the encapsulated nanoparticles.

### BACKGROUND OF THE INVENTION

There exists a need in the art for compositions that provide one or more of the following benefits: (1) increased weaving efficiency in the textile industry; (2) increased fiber-to-fiber interaction within a given yarn or multifilament synthetic fiber; (3) increased fiber-to-fiber interaction within a nonwoven fabric; (4) a reduction of yarn or fiber hairiness due to low fiber cohesion within the yarn of fiber; (5) a solid particulate material containing dispersed components suitable for use in the textile industry; and (6) an oil-containing composition containing dispersed components suitable for use in the textile industry.

### SUMMARY OF THE INVENTION

The present invention addresses some of the difficulties and problems discussed above by the discovery of compositions containing encapsulated nanoparticles. The compositions of the present invention contain dispersed, stabilized encapsulated nanoparticles alone or in combination with other materials. The compositions may be solid wax-containing particles or oil-containing compositions having a variety of uses. The compositions of the present invention find particular utility as textile sizing materials, and fiber coating materials.

Accordingly, the present invention is directed to compositions comprising a plurality of nanoparticles; a nanoparticle encapsulating material that encapsulates individual nanoparticles to form a plurality of encapsulated nanoparticles; and a stabilizing agent, wherein the stabilizing agent reduces a tendency of the plurality of encapsulated nanoparticles to conglomerate. In one exemplary embodiment, the composition comprises nanoparticles; a first encapsulating material that encapsulates individual nanoparticles to form encapsulated nanoparticles; and a stabilizing agent, wherein the stabilizing agent reduces a tendency of the encapsulated nanoparticles to conglomerate, and the stabilizing agent comprises at least one polyhydroxyl compound.

In other embodiments of the present invention, the composition may further comprise a carrier material at least partially encapsulating the stabilizing agent and encapsulated nanoparticles. For example, in one embodiment of the present invention, the composition comprises nanoparticles; a first encapsulating material that encapsulates individual nanoparticles to form encapsulated nanoparticles; a stabilizing agent, wherein the stabilizing agent reduces a tendency of encapsulated nanoparticles to conglomerate; and a water-insoluble carrier material encapsulating the stabilizing agent and encapsulated nanoparticles, wherein a plurality of individual masses of stabilizing agent in combination with encapsulated nanoparticles is distributed within the carrier material. The carrier material may be a wax, oil, or other carrier material. In one embodiment of the present invention, a plurality of stabilized encapsulated nanoparticles (i.e., the stabilizing agent and encapsulated nanoparticles) is substantially uniformly distributed throughout the carrier material.

The present invention is also directed to methods for making encapsulated nanoparticles and compositions containing the same. In one exemplary embodiment of the present invention, the method for making a composition comprising the step of stabilizing a plurality of encapsulated nanoparticles by combining the plurality of encapsulated nanoparticles with a stabilizing agent that reduces a tendency of the encapsulated nanoparticles to conglomerate with one another, wherein the stabilizing agent comprising at least one polyhydroxyl compound. In a further embodiment of the present invention, the method for making a composition comprises the step of forming a mixture of individual masses of stabilized encapsulated nanoparticles distributed within a water-insoluble carrier material, wherein the water-insoluble carrier material comprises a wax; an oil; an alkyl ester; or a surfactant system containing a fatty acid. The methods for making compositions of the present invention may include a number of additional steps.

The present invention is further directed to methods of using the encapsulated nanoparticles and compositions containing the same. Methods of using the compositions and/or composition components of the present invention include, but are not limited to, coating a substrate with the composition and/or composition component. A variety of substrates may be coated with the compositions and/or composition components of the present invention including, but are not limited to, textile yarns and fabrics.

These and other features and advantages of the present invention will become apparent after a review of the following detailed description of the disclosed embodiments and the appended claims.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the present invention is intended by the use of specific language. Alterations, further modifications, and such further applications of the principles of the present invention discussed are contemplated as would normally occur to one ordinarily skilled in the art to which the invention pertains.

The present invention is directed to a combination of ingredients, and those skilled in the art may find ways to alter that combination by means of further chemical additions to the solution specifically disclosed and claimed. Moreover, the amounts set out in embodiments and even the claims may be changed and still achieve the benefits of the present invention. Such modifications are considered to be within the scope of the present invention, as set out in the attached claims and their equivalents.

The present invention is directed to compositions containing stabilized encapsulated nanoparticles. The compositions may further include a carrier material, such as a wax, an oil, or other carrier materials, and at least one optional emulsifier to further distribute the stabilized encapsulated nanoparticles throughout the carrier material. The compositions may be used in a variety of applications, such as a sizing composition for textile applications. The present invention is further directed to methods of making the compositions containing stabilized encapsulated nanoparticles, as well as, methods of using the compositions containing stabilized encapsulated nanoparticles in a variety of applications.

The compositions of the present invention comprise a number of components, each of which are described in detail below.

### I. Composition Components

The compositions of the present invention comprise a number of components, which provide desired characteristics to the resulting products. The compositions of the present invention may include one or more of the following components: encapsulated nanoparticles, a stabilizing agent or system, a carrier system, and an emulsifier system. A description of each class of components is given below.
A. Encapsulated Nanoparticles

The compositions of the present invention comprise encapsulating nanoparticles. The encapsulating nanoparticles comprise one or more of the following components.
1. Nanoparticles

The encapsulating nanoparticles of the present invention comprise a plurality of nanoparticles. The plurality of nanoparticles may comprise any nanoparticles, which are capable of being formed into an aqueous dispersion of nanoparticles. The plurality of nanoparticles may comprise a single type of nanoparticles (e.g., silica nanoparticles) or may comprise two or more types of nanoparticles (e.g., silica nanoparticles and tin oxide nanoparticles). Suitable nanoparticles include, but not limited to, metal oxides, ceramic nanoparticles, or a combination thereof. The choice of nanoparticle type will depend on the given application. In a number of applications, such as compositions for the textile industry, the nanoparticles are desirably metal oxide nanoparticles.

Any metal oxide nanoparticle may be used in the present invention. Suitable metal oxide nanoparticles include, but are not limited to, metal oxides of Si, Zr, Zn, Sn, Y, Sb and Ce. Desirably, the metal oxide nanoparticles comprise silica, tin oxide, antimony pentoxide, and combinations thereof. More desirably, the nanoparticles comprise silica nanoparticles.

The nanoparticles generally have an average particle diameter of up to about 150 nm. Desirably, the nanoparticles have an average particle diameter ranging from about 4 to about 150 nm, more desirably, from about 10 to 100 nm. As used herein, “average particle diameter” refers to the average diameter of a given particle. For example, if the particle is substantially spherical, the “average particle diameter” of the particle is the actual diameter of the substantially spherical particle. If the particle is not spherical, the “average particle diameter” of the particle is the average length of the largest dimension of the particle.

Suitable commercially available nanoparticles include, but are not limited to, nanoparticles available under the trade designation NALCOAG® from Nalco (Chicago, Ill.); nanoparticles available under the trade designation NYACOL® from EKA NOBEL (Marietta, Ga.); and nanoparticles available under the trade designation LUDOX® from DuPont (Wilmington, Del.).
2. Nanoparticle Encapsulating Materials

The encapsulated nanoparticles further comprise a nanoparticle encapsulating material. Desirably, each nanoparticle within the plurality of nanoparticles is completely encapsulated by the nanoparticle encapsulating material to prevent conglomeration of individual nanoparticles with one another. However, it should be noted that many encapsulated nanoparticles of the present invention may actually comprise several nanoparticles present within a single nanoparticle encapsulating material.

The nanoparticle encapsulating materials used in the present invention are capable of forming a sufficiently complete film around the nanoparticles, such as colloidal metal oxide particles, to prevent the nanoparticles from disassociating from the encapsulating material and forming large 3-dimensional inorganic polymer networks. Such encapsulating materials are desirably polymeric materials, such as polyester polymer resins.

The nanoparticle encapsulating material may be a variety of materials including, but not limited to, polyesters, hydrophobic polyacrylates, water-dispersible polyurethanes, water-dispersible polyamides, and combinations thereof. In one desired embodiment of the present invention, the nanoparticle encapsulating material comprises a polyester resin. Suitable polyester resins include, but are not limited to, polyester polymer resins formed from isophthalic acid, diethylene glycol, trimellitic anhydride, terephthalic acid, phthalic anhydride, hexane dioic acid, maleic acid, maleic anhydride, and combinations thereof. Other suitable polyester resins include, but are not limited to, polyester polymer resins disclosed in U.S. Pat. No. 4,268,645, the subject matter of which is incorporated herein by reference. Desirably, the polyester resin comprises a polyester resin formed from isophthalic acid, terephthalic acid, diethylene glycol, and trimellitic anhydride, and has been neutralized with a hydroxylamine-containing material to render the polymer resin reducible in water. Suitable hydroxylamine-containing materials include, but are not limited to, monoisopropylamine, N-methylethanolamine, α-hydroxyamines such as mono-, di-, and triethanol amines, and combinations thereof. Particularly suitable polyester resins comprise those formed from isophthalic acid, terephthalic acid, diethylene glycol, and trimellitic anhydride; neutralized using an α-hydroxyamine, such as ethanolamine; and having a number average molecular weight of from about 1,500 to about 7,000 daltons.

In the above-described desired embodiment, the resulting encapsulated nanoparticles may be dispersed in an aqueous solution containing as much as 85 weight percent (wt %) or more of water. In other embodiments, the resulting encapsulated nanoparticles may be dispersed in an aqueous solution containing less than about 85 wt % water, and desirably are dispersed in an aqueous solution containing from about 30 wt % to about 85 wt % water. These resulting encapsulated nanoparticles are particularly useful for use in “stabilized encapsulated nanoparticle” systems described below.

In a further desired embodiment of the present invention, the nanoparticle encapsulating material comprises a hydrophobic organic acid neutralized with one or more of the above-mentioned hydroxyamine compounds. Suitable hydrophobic organic acids include, but are not limited to, octanoic (caprylic) acid, nonanoic (pelargonic) acid, decanoic (capric) acid, dodecanoic (lauric) acid, myristic acid, palmitic acid, stearic acid, palmitoleic acid, oleic acid, linoleic acid, aromatic acids comprising any of the above-mentioned hydrophobic acids substituted with one or more aromatic groups. Other hydrophobic acids suitable for use in the present invention include hydrophobic acid polymers including, but not limited to, hydrophobic alkene/acrylic acid copolymers. Suitable hydrophobic alkene/acrylic acid copolymers may be formed from alkene groups have any number of carbon atoms present in the polymerizable monomer as long as the resulting polymer is hydrophobic. Typically, the alkene groups used to form the hydrophobic alkene/acrylic acid copolymers contain up to about 6 carbon atoms. Desirably, the neutralized hydrophobic organic acids comprise one of the above-mentioned hydrophobic acids neutralized with ethanolamine. The resulting encapsulated nanoparticles are particularly useful in non-aqueous carrier systems described below.

The ratio of nanoparticle encapsulating material to nanoparticles is desirably sufficiently high to result in substantially complete encapsulation or occlusion of each of the nanoparticles so that the plurality of nanoparticles remains substantially discrete, rather than agglomerating. A simple test may be used to confirm the adequacy of metal oxide particle encapsulation based on the superior insulating properties of silica. A sample of encapsulated nanoparticles may be heated to about 600° C. for about 1 to 3 hours to obtain a resulting fired residue. If a sufficient amount of a suitable nanoparticle encapsulating material has been used, the resulting silica residue is very fine and white. If an insufficient amount of a suitable nanoparticle encapsulating material (or an unsuitable nanoparticle encapsulating material) is used, the resulting residue is black due to the presence of carbon from trapped, insulated encapsulating material within the agglomerated 3-dimensional silica structure.

The amount of nanoparticle encapsulating material required for a specific nanoparticle composition depends upon the particle size of the nanoparticles. Smaller particles have higher surface areas and require higher amounts of encapsulating material. Generally, however, the nanoparticles and the nanoparticle encapsulating material are present at a weight ratio of from about 1:3 to about 1:15 based on total solids and surface area of the nanoparticles to be encapsulated.

In one desired embodiment of the present invention, the encapsulated nanoparticles comprise (i) silica nanoparticles having an average particle diameter of about 15-20 nanometers, and (ii) a completely encapsulating coating of a polyester formed by polymerizing one or more components selected from isophthalic acid, terephthalic acid, phthalic anhydride, diethylene glycol and trimellitic anhydride, and neutralized with an α-hydroxyamine. In this desired embodiment, the silica nanoparticles and the neutralized polyester are present at a weight ratio ranging from about 1:3 to about 1:15 based on total solids of nanoparticles and nanoparticle encapsulating material within the encapsulated nanoparticles.

In a further desired embodiment of the present invention, the encapsulated nanoparticles comprise (i) silica nanoparticles having an average particle diameter of about 15-20 nanometers, and (ii) a completely encapsulating coating of a hydrophobic organic acid neutralized with a hydroxyamine compound. This encapsulating material is formed by neutralization of a hydrophobic monomeric acid or hydrophobic polymeric acid with a hydroxylamine, such as an alpha-hydroxylamine. In this desired embodiment, the silica nanoparticles and the neutralized hydrophobic organic acid are present at a weight ratio ranging from about 1:3 to about 1:15 based on total solids of nanoparticles and nanoparticle encapsulating material within the encapsulated nanoparticles. For example, the encapsulated nanoparticle may desirably comprise colloidal silica encapsulated with oleic acid neutralized with ethanolamine.

The encapsulating nanoparticles of the present invention desirably have an average particle diameter of up to about 150 nm. More desirably, the encapsulating nanoparticles have an average particle diameter ranging from about 4 nm to about 100 nm.

Suitable commercially available encapsulating materials include, but are not limited to, polyester resins commercially available under the trade designation PT-125 from Polytech Inc. (Greer, S.C.). Suitable commercially available encapsulating starting materials include, but are not limited to, hydrophobic organic acids commercially available from Crompton, Inc (Memphis, Tenn.) under the trade designations INDUSTRENE®; and hydroxylamines commercially available from Dow Chemical (Midland, Mich.).
B. Stabilizing Agent or System Used To Form Stabilized Encapsulating Nanoparticles

The above-described encapsulated nanoparticles may be combined with one or more stabilizing agents to form dispersed encapsulated nanoparticles. As used herein, the term “stabilized encapsulated nanoparticles” refers to any one of the above-described encapsulated nanoparticles in combination with at least one stabilizing agent. Suitable stabilizing agents for use in the present invention, include, but are not limited to, polyacrylamides, polyacrylamide copolymers, polyalkylene oxides, ethoxylated starches, simple carbohydrates, polyhydroxyl compounds, and combinations thereof. In one desired embodiment, the stabilizing agent comprises a polyacrylamide or an aqueous solution containing polyacrylamide. In a further desired embodiment, the stabilizing agent comprises a polyhydroxyl compound.
1. Polyacrylamide Polymers and Copolymers

In one exemplary embodiment of the present invention, stabilized encapsulated nanoparticles are formed using polyacrylamide polymers as the stabilizing agent. As used herein, the term “polyacrylamide polymers” include homopolymers containing acrylamide or methacrylamide, while the term “polyacrylamide copolymers” include copolymers of acrylamide, methacrylamide, other additional monomers, and combinations thereof. Desirably, the polyacrylamide polymer or copolymer is produced by a solution polymerization procedure, as opposed to a bulk, suspension, emulsion or inverse emulsion polymerization technique, and has a linear (i.e., unbranched) polymeric structure with no crosslinking between polymer chains. The linear, solution polymerized polyacrylamides desirably have a low molecular weight as evidenced by a viscosity of a 20 wt % aqueous solution thereof being only about 400 to about 2,500 cps, desirably about 500 to about 1,000 cps, as determined by a Brookfield RVT Viscometer at 25° C. using spindle #3 at 50 RPM. Although a small amount of acid groups may be present due to copolymerization or by hydrolysis of the amide groups, desirably, in one embodiment of the present invention, the polyacrylamides have a minimal amount of acid groups along the polymer chain. The presence of a large number of acid groups has been found to be undesirable in applications such as textile sizing applications, particularly in high moisture level environments as is common in weaving rooms.

Polyacrylamide copolymers containing acrylamide and/or methacrylamide with other additional monomers may also be used as a stabilizing agent in the present invention. Suitable copolymerizable monomers include, but are not limited to, acrylonitrile, acrylic acid, methacrylic acid, vinyl acetate, and combinations thereof. When present in the polyacrylamide copolymers, the additional copolymerizable monomers are typically present in an amount of up to about 25 mole % based on the total moles of the resulting copolymer. The resulting linear copolymers provide stabilization to encapsulated nanoparticle systems, and especially encapsulated nanoparticles comprising silica encapsulated with a hydrophobic organic acid neutralized with a hydroxylamine compound or polymer.

Any conventional acrylamide solution polymerization technique may be used to prepare the solution polyacrylamide polymers or copolymers used herein. Generally, acrylamide monomers and additional monomers are polymerized in an aqueous medium, under an inert atmosphere, and in the presence of a catalytic amount of a free-radical source such as ammonium persulfate, ammonium persulfate, sodium bisulfite, and the like. The reaction mixture is stirred under the inert atmosphere until the polymerization is completed. The resulting product is a slightly viscous solution, which, depending upon its solids content, may be directly used in the present invention or may be diluted to a lower solids level. Desirably, the resulting polyacrylamide polymer or copolymer is substantially free from crosslinking.

A particularly suitable polyacrylamide polymer for use in the present invention is available from Callaway Chemical Company (Columbus, Ga.) as CALLAWAY 4600. Other polyacrylamide polymers for use in the present invention include polyacrylamide polymers commercially available from Chemtall, Inc. (Riceborough, Ga.) and Ciba Chemicals (Suffolk, Va.).
2. Polyhydroxyl Compounds

In a further exemplary embodiment of the present invention, stabilized encapsulated nanoparticles are formed using water-soluble polyhydroxyl compounds as the stabilizing agent. As used herein, the term “polyhydroxyl” refers to compounds have contain two or more hydroxyl groups. The term “polyhydroxyl” does not refer to polymeric materials or polymeric materials having two or more hydroxyl groups. Suitable polyhydroxyl compounds for use in the present invention include, but are not limited to, glycerol; ethylene glycol; diethylene glycol; monosaccharides, such as glucose; and combinations thereof.

In this embodiment, the stabilizing agent comprises one or more of the above-mentioned polyhydroxyl compounds, and typically does not contain any polymeric stabilizing components such as the polyacrylamide polymers and copolymers described above.

The above-mentioned polyhydroxyl compounds are commercially available from a number of companies including, but not limited to, Lynx Chemical Group (Columbus, Ga.), Union Carbide (Seadrift, Tex.), and Imperial Sugar Company (Sugar Land, Tex).

When used as the stabilizing agent, the stabilized encapsulated nanoparticle system typically comprises up to about 60 wt % of one or more polyhydroxyl compounds, and up to about 40 wt % of encapsulated nanoparticles, based on a total weight of the stabilized encapsulated nanoparticle system. Desirably, the stabilized encapsulated nanoparticle system comprises up to about 60 wt % of one or more polyhydroxyl compounds, and from about 25 wt % to about 30 wt % of encapsulated nanoparticles, based on a total weight of the stabilized encapsulated nanoparticle system, with the balance being water and optional additives described below.
3. Stabilized Encapsulated Nanoparticle Systems

The stabilized encapsulated nanoparticles may be prepared by simply combining the above-described encapsulated nanoparticles and the stabilizing agent, and mixing until a homogeneous system is formed. This procedure is particular useful when the stabilizing agent comprises an aqueous solution. The stabilizing agent, such as a linear polyacrylamide polymer, can be added to a previously prepared composition containing the above-described encapsulated nanoparticles. In another alternative embodiment, the above-described encapsulated nanoparticles are incorporated into a reaction solution containing acrylamide monomers, which are subsequently polymerized to form a linear polyacrylamide matrix containing the above-described encapsulated nanoparticles. The linear polyacrylamide matrix polymer mixture may be isolated to provide a stable non-aqueous encapsulated nanoparticle mixture.

Generally, the weight ratio of stabilizing agent to encapsulated nanoparticles ranges from about 95:1 to about 1:3 based on total solids of stabilizing agent and encapsulated nanoparticles. In one desired embodiment of the present invention, the stabilizing agent comprises linear polyacrylamide, the encapsulated nanoparticles comprise silica nanoparticles encapsulated by a neutralized polyester, and the stabilizing agent and encapsulated nanoparticles are present at a weight ratio of from about 9.5:0.5. In a further desired embodiment of the present invention, the stabilizing agent comprises linear polyacrylamide, the encapsulated nanoparticles comprise silica nanoparticles encapsulated by a neutralized polyester, and the stabilizing agent and encapsulated nanoparticles are present at a weight ratio of from about 1:3.

In a further embodiment of the present invention, the stabilized encapsulated nanoparticles comprise (i) silica nanoparticles having an average particle diameter of about 15-20 nanometers, (ii) a completely encapsulating coating of a polyester formed by polymerizing one or more components selected from isophthalic acid, terephthalic acid, diethylene glycol and trimellitic anhydride, and neutralized with an α-hydroxyamine, wherein the silica nanoparticles and the neutralized polyester are present at a weight ratio of from about 1:3 to about 1:15; and (iii) a stabilizing agent comprising a linear polyacrylamide formed using a solution polymerization procedure, wherein the linear polyacrylamide and the encapsulated nanoparticles are present at a weight ratio of from about 15:1 to about 1:3.

In yet a further embodiment of the present invention, the stabilized encapsulated nanoparticles comprise (i) silica nanoparticles having an average particle diameter of about 15-20 nanometers, (ii) a completely encapsulating coating of a polyester formed by polymerizing one or more components selected from isophthalic acid, terephthalic acid, diethylene glycol and trimellitic anhydride, and neutralized with an α-hydroxyamine, wherein the silica nanoparticles and the neutralized polyester are present at a weight ratio of from about 1:3 to about 1:15; and (iii) a stabilizing agent comprising one or more polyhydroxyl compounds, wherein the one or more polyhydroxyl compounds and the encapsulated nanoparticles are present at a weight ratio of from about 5:1 to about 1:5.

In yet a further embodiment of the present invention, the stabilized encapsulated nanoparticles comprise (i) silica nanoparticles having an average particle diameter of about 15-20 nanometers, (ii) a completely encapsulating coating of a hydrophobic acid neutralized with a hydroxylamine compound as described above, wherein the silica nanoparticles and the neutralized hydrophobic acid are present at a weight ratio of from about 1:3 to about 1:15; and (iii) a stabilizing agent comprising one or more polyhydroxyl compounds, wherein the one or more polyhydroxyl compounds and the encapsulated nanoparticles are present at a weight ratio of from about 5:1 to about 1:5.

In a number of applications, such as textile size composition applications, the stabilized encapsulated nanoparticles may further contain urea. The urea is desirably uniformly distributed (i) within a solution of stabilizing agent material. The urea may be present in an amount of greater than about 50 wt %, based on a total weight of the stabilizing agent. Desirably, the urea is present in an amount ranging from about 5 to about 50 wt %, based on a total weight of the stabilizing agent. More desirably, the urea is present in an amount ranging from about 10 to about 40 wt %, based on a total weight of the stabilizing agent. When urea is present, the urea may be added to any of the above-described solutions before or after blending of the stabilizing agent and the encapsulated nanoparticles.

In embodiments of the present invention wherein the stabilized encapsulated nanoparticles comprises solid particles of encapsulated nanoparticles coated with an outer coating of stabilizing agent, the solid stabilized encapsulated nanoparticles desirably have an average particle diameter of up to about 150 nm. More desirably, the solid stabilized encapsulated nanoparticles have an average particle diameter ranging from about 4 nm to about 100 nm.
C. Carrier Systems

The above-described encapsulating nanoparticles and/or stabilized encapsulating nanoparticles may be further encapsulated by a solid or liquid carrier system comprising at least one of the following components.
1. Solid Wax Carrier

The above-described stabilized encapsulating nanoparticles may be incorporated into a wax. Suitable waxes include natural and synthetic waxes. Exemplary waxes include, but are not limited to, tallow glyceride esters and their hydrogenated derivatives, hydrocarbon-based waxes, and combinations thereof.

Suitable commercially available waxes that may be used in the present invention include, but are not limited to, tallow glycerides and derivatives thereof commercially available under the trade designation NEUSTRENE from Crompton Corporation (Memphis, Tenn.).

Desirably, the wax completely encompasses the encapsulated nanoparticles, regardless of whether the stabilized encapsulating nanoparticles are solid encapsulated nanoparticles as described above or individual masses of aqueous solution containing stabilizing agent, encapsulated nanoparticles and water. Desirably, at least one emulsifier is used in combination with the wax to assist in distributing the solid stabilized encapsulated nanoparticles and/or individual masses throughout the wax. In a desired embodiment of the present invention, the solid stabilized encapsulating nanoparticles and/or individual masses are uniformly distributed throughout the wax.

The wax and the stabilized encapsulating nanoparticles may be present in the wax composition at a weight ratio ranging from about 5:1 to about 1:5 (wax:stabilized encapsulating nanoparticles). Desirably, the wax and the stabilized encapsulating nanoparticles are present in the wax composition at a weight ratio of about 1:3.

In one desired embodiment of the present invention, the wax composition comprises (i) silica nanoparticles having an average particle diameter of about 20 nanometers; (ii) a completely encapsulating coating of a polyester formed by polymerizing one or more components selected from isophthalic acid, terephthalic acid, phthalic anhydride, diethylene glycol and trimellitic anhydride, and neutralized with an α-hydroxyamine, wherein the silica nanoparticles and the neutralized polyester are present at a weight ratio of from about 1:3 to about 1:15; (iii) a stabilizing agent comprising polyacrylamide, wherein the polyacrylamide and the encapsulated nanoparticles are present at a weight ratio of from about 15:1 to about 1:2; and (iv) a carrier material comprising a wax selected from the group consisting of a tallow glyceride ester, a hydrogenated tallow glyceride ester, a hydrocarbon-based wax, and combinations thereof, wherein the wax and the stabilized encapsulated nanoparticles (i.e., the stabilizing agent in combination with the encapsulated nanoparticles) are present at a weight ratio of from about 95:5 to about 1:3.

In one embodiment of the present invention, the above-described wax-containing composition is in the form of a solid particle or a plurality of solid particles. The solid particles may be used alone or combined with other solid particles to form a variety of dry blends. Suitable dry blends of the present invention include the solid particles of the present invention in combination with one or more of the following components: polyvinyl alcohol, starch, carboxymethyl cellulose, urea, and other waxes.
2. Oils

Alternatively or in addition to the above-described waxes, one or more oils may be used as a carrier for the stabilized encapsulated nanoparticles. Suitable oils include, but are not limited to, vegetable oils, petroleum oils, and combinations thereof. Exemplary oils suitable for use in the present invention include, but are not limited to, vegetable oils, petroleum oils, and combinations thereof. In one desired embodiment of the present invention, the oil comprises petroleum-derived mineral oil.

Suitable commercially available oils that may be used in the present invention include, but are not limited to, deodorized kerosene available under the trade designation ESCAID® 110 from Exxon Mobil (Houston, Tex.); and petroleum derived mineral oils available from Exxon Mobil.

Similar to the above-described embodiments comprising a wax, it is desirable for the oil to completely encapsulate the stabilized encapsulating nanoparticles. Desirably, at least one emulsifier is used in combination with the oil to assist in distributing the stabilized encapsulated nanoparticles throughout the oil. In a desired embodiment of the present invention, the stabilized encapsulated nanoparticles are uniformly distributed throughout the oil.

The oil and the stabilized encapsulating nanoparticles may be present in the oil composition at a weight ratio ranging from about 25:1 to about 1:10 (oil:stabilized encapsulated nanoparticles). Desirably, the oil and the stabilized encapsulated nanoparticles are present in the oil composition at a weight ratio of about 9:1 to about 1:5.

In one desired embodiment of the present invention, the oil-containing composition comprises (i) silica nanoparticles having an average particle diameter of about 20 nanometers; (ii) a completely encapsulating coating of a polyester formed by polymerizing one or more components selected from isophthalic acid, terephthalic acid, phthalic anhydride, diethylene glycol and trimellitic anhydride, and neutralized with an α-hydroxyamine, wherein the silica nanoparticles and the neutralized polyester are present at a weight ratio of from about 1:3 to about 1:15; (iii) a stabilizing agent comprising polyacrylamide, wherein the polyacrylamide and the encapsulated nanoparticles are present at a weight ratio of from about 15:1 to about 1:2; and (iv) a carrier material comprising an oil, wherein the oil and the stabilized encapsulated nanoparticles (i.e., the stabilizing agent in combination with the encapsulated nanoparticles) are present at a weight ratio of from about 25:1 to about 1:5.

In one embodiment of the present invention, the above-described oil-containing compositions are used alone or in combination with other components to form a variety of oil-containing products. Suitable oil-containing products of the present invention include the oil-containing compositions of the present invention in combination with one or more of the following components: water-soluble esters of polyethylene glycols.
3. Emulsifiers

As discussed above, the waxes and/or oils are desirably used in combination with at least one emulsifier. A variety of emulsifiers may be used in the present invention providing that the individual emulsifiers and any combinations thereof have properties, which generate water-in-oil emulsions when sheared into mixtures of such. Desirably, the emulsifier or emulsifier system (i.e., a combination of emulsifiers) has a combined HLB (Hydrophile-Lipophile Balance) value of about 9 to about 13. Typically, the emulsifier or emulsifier system used in the present invention comprises one or more nonionic polymers or compounds. Suitable emulsifiers include, but are not limited to, polymeric surfactants, sorbitan monooleate, and combinations thereof. In one desired embodiment of the present invention, at least one emulsifier is combined with the carrier material, wherein the at least one emulsifier comprises a blend of polymeric surfactant and sorbitan monooleate surfactant. In a further desired embodiment of the present invention, the blend comprises about 2 parts by weight (pbw) polymeric surfactant and about 1 pbw sorbitan monooleate surfactant.

Suitable polymeric surfactants include, but are not limited to, nonionic polymers having hydrophilic and hydrophobic units along the nonionic polymer chain. Exemplary nonionic polymer surfactants are commercially available under the trade designation HYPERMER™ from Uniqema Corporation (New Castle, Del.). In one desired embodiment, a polymeric surfactant commercially available under the trade designation HYPERMER™ 1031 from Uniqema Corporation (New Castle, Del.) is used as at least one emulsifier.

Other suitable commercially available surfactants include, but are not limited to, sorbitan monooleate surfactants available under the trade designation ATLAS™ from Uniqema Corporation (New Castle, Del.), such as ATLAS™ G-946; and sorbitan monooleate surfactants available under the trade designation SPAN™ from Uniqema Corporation (New Castle, Del.), such as SPAN™ 20 or SPAN™ 80.

When combined with a wax-containing composition, it is desirable for the at least one emulsifier to be present in an amount of up to about 6 parts by weight (pbw) for every 100 pbw of wax. When combined with an oil-containing composition, it is desirable for the at least one emulsifier to be present in an amount of up to about 10 parts by weight (pbw) for every 100 pbw of oil.
4. Alkyl Esters The above-described encapsulated nanoparticles and stabilized encapsulated nanoparticles may be incorporated into a carrier comprising one or more alkyl esters. Suitable alkyl esters include, but are not limited to, methyl esters of alkyl acids derived from naturally occurring fatty glycerides, and combinations thereof. Exemplary alkyl esters suitable for use in the present invention include, but are not limited to, liquid methyl esters of saturated or unsaturated alkyl acids having from about 4 to about 28 carbon atoms (more desirably, from about 8 to about 24 carbon atoms) in the alkyl chain, and combinations thereof. In one desired embodiment of the present invention, the alkyl ester comprises methyl esters of octadecenoic acid.

It is desirable for the one or more alkyl esters to completely encapsulate the encapsulating nanoparticles or stabilized encapsulated nanoparticles. At least one of the above-described emulsifiers may be used in combination with the alkyl ester(s) to assist in distributing the encapsulated nanoparticles throughout the alkyl ester(s). In a desired embodiment of the present invention, the encapsulated nanoparticles or stabilized encapsulated nanoparticles are uniformly distributed throughout the one or more alkyl esters. Further, in a desired embodiment of the present invention, the encapsulated nanoparticles used in combination with the one or more alkyl esters comprise the above-described encapsulating nanoparticles having an encapsulating material in the form of a hydrophobic organic acid neutralized with a hydroxyamine compound.

The one or more alkyl esters and the encapsulated nanoparticles may be present in the one or more alkyl ester composition at a weight ratio ranging from about 15:1 to about 1:15 (one or more alkyl esters:encapsulated nanoparticles). Desirably, the one or more alkyl esters and the encapsulated nanoparticles are present in the one or more alkyl ester composition at a weight ratio of about 3:1 to about 1:15.
5. Surfactant Systems

The above-described stabilized encapsulated nanoparticles may also be incorporated into a foamable carrier system comprising one or more surfactants in combination with one or more fatty alcohols having from about 12 to about 18 carbon atoms in an alkyl chain. Suitable surfactants for use in the present invention include, but are not limited to, high-foaming anionic surfactants, high-foaming nonionic surfactants, and amphoteric surfactants. Anionic surfactants include, but are not limited to, dodecyl benzene sulfonic acid and its salts, alkyl ether sulfates and salts thereof, olefin sulfonates, phosphate esters, soaps, sulfosuccinates, and alkyaryl sulfonates. Nonionic surfactants include, but are not limited to, alkoxylates of alkyl phenols and alcohols, and alkanolamides. Specific examples of suitable high-foaming surfactants include, but are not limited to, dodecyl benzene sulfonic acid and its salts, nonyl phenoxy ethoxylate, ethoxylated alcohol containing from about 9 to about 15 carbon atoms, diethanol coconut amide, sodium lauryl ether sulfate, dioctylsulfosuccinate, and combinations thereof. Suitable fatty alcohols include, but are not limited to, lauryl alcohol (C12), myristyl alcohol (C14), cetyl alcohol (C16), stearyl alcohol (C18), oleyl alcohol (C18, unsaturated), and linoleyl alcohol (C18), and combinations thereof.

Typically, a foamable carrier system comprises up to about 20 wt % of one or more surfactants, and up to about 5 wt % of one or more fatty alcohols based on a total weight of the foamable carrier system with the balance being water and other possible additives described below. Desirably, the foamable carrier system comprises from about 0.5 wt % to about 20 wt % of one or more surfactants, and from about 0.2 wt % to about 10 wt % of one or more fatty alcohols based on a total weight of the foamable carrier system with the balance being water and other possible additives described below.

In one exemplary embodiment of the present invention, the foamable carrier system comprises about 10 wt % of dioctylsulfosuccinate (6% solution), about 1 wt % of lauryl alcohol, and about 89 wt % water, based on a total weight of the sprayable carrier system.
D. Additives

The compositions of the present invention may contain one or more additives to provide a desired characteristic to the resulting product. Suitable additives include, but are not limited to, dyes, pigments, perfumes, preservatives, antimicrobial agents, hydrotropes, corrosion inhibitors, abrasives, anti-redeposition agents, softeners, conditioners, humectants, wetting modification agents, and combinations thereof. In one desired embodiment of the present invention, the compositions comprise at least one biocide in an amount of up to amount 1.0 wt %, more desirably, about 0.1 wt %, based on a total weight percent of the composition.

Typically, additives, such as those mentioned above, are each individually present in an amount of less than about 2.0 wt % based on a total weight of the composition. Desirably, each additive, when present, is individually present in an amount ranging from about greater than zero (≧0 ) to about 0.5 wt % based on a total weight of the composition.

A number of commercially available additives may be used in the present invention. Commercially available dyes suitable for use in the present invention include, but are not limited to, Yellow Dye FD&C#5 available from Pylam Products (Tempe, Ariz.); Blue Pylaklor LX 10092 available from Pylam Products (Tempe, Ariz.); Resorcine Brown 5GM available from Pylam Products (Tempe, Ariz.); and Tartrazine Yellow available from Chemcentral (Romulus, Mich.). Commercially available perfumes suitable for use in the present invention include, but are not limited to, perfume SZ-6929 (Apple) available from J. E. Sozio, Inc. (Edison, N.J.); Citrus SZ 6242 available from J. E. Sozio, Inc. (Edison, N.J.); and MF 3773 (lemon) available from Mane, U.S.A. (Wayne, N.J.). Commercially available preservatives suitable for use in the present invention include, but are not limited to, preservatives sold under the trade designation KATHON™ from Rohm & Haas (Philadelphia, Pa.) and ACTICIDE™ from Actichem (Trumbull, Conn.).

### II. Methods For Making Compositions

The present invention is also directed to methods for making the above-described compositions and components therein. The compositions of the present invention may be prepared using conventional mixing techniques. The possible components for forming the compositions of the present invention, namely, one or more of the encapsulated nanoparticles, the stabilizing agent, the carrier material, and the emulsifier, may be combined using a variety of conventional techniques.

In one desired embodiment of the present invention, the method for making a composition comprises the steps of forming a mixture of at least one emulsifier and a carrier material, wherein the carrier material comprises a melted wax or oil; and incorporating stabilized encapsulated nanoparticles into the mixture, wherein the stabilized encapsulated nanoparticles comprise (a) a plurality of nanoparticles, (b) a first encapsulating material at least partially (and more desirably, completely) encapsulating individual nanoparticles, and (c) a stabilizing agent, wherein the stabilizing agent reduces a tendency of the encapsulated nanoparticles to conglomerate with one another.

When the carrier material comprises a wax, the method for making a composition may further comprise one or more of the following steps: heating the wax to a temperature of above 10 to 15° C. above the melt point of the wax to form a melted wax; incorporating at least one emulsifier into the melted wax; mixing the melted wax mixture; and after incorporating stabilized encapsulated nanoparticles into the melted wax, cooling the mixture to a temperature below the melt point of the wax to form a solid wax.

The solid wax product may be formed into a plurality of solid particles using any conventional technique including, but not limited to, flaking, and prilling. As described above, desirably, each solid particle within the plurality of solid particles comprises a matrix of solid wax and stabilized encapsulated nanoparticles uniformly distributed within the matrix.

When the carrier material comprises an oil, the method for making a composition does not require a heating step.

In a further desired embodiment of the present invention, the method for making a composition comprises the steps of providing a carrier material, wherein the carrier material comprises an alkyl ester; and incorporating encapsulated nanoparticles into the carrier material, wherein the encapsulated nanoparticles comprise (a) a plurality of nanoparticles, and (b) a first encapsulating material at least partially (and more desirably, completely) encapsulating individual nanoparticles, wherein the first encapsulating material comprises an acid-neutralized alpha-hydroxyamine compound and reduces a tendency of the encapsulated nanoparticles to conglomerate with one another.

The method for forming compositions of the present invention may further include one or more of the following steps: forming a desired encapsulating material; encapsulating nanoparticles with an encapsulating material to form the encapsulated nanoparticles; and stabilizing encapsulated nanoparticles with a stabilizing agent to form stabilized encapsulated nanoparticles. Suitable methods for forming encapsulated nanoparticles include, but are not limited to, methods disclosed in U.S. Pat. Nos. 4,728,679 and 4,997,862, the subject matter of which is herein incorporated by reference in their entirety. Suitable methods for forming stabilized encapsulated nanoparticles include, but are not limited to, methods disclosed in U.S. Pat. No. 5,965,636, the subject matter of which is herein incorporated by reference in its entirety.

In one exemplary embodiment of the present invention, the method for making a composition comprises the step of forming a desired encapsulating material, wherein the desired encapsulating material comprises a hydrophobic organic acid neutralized with an alpha-hydroxyamine compound. In this embodiment, the neutralized acid may be formed using the following exemplary steps:
(1) a carboxylated hydrophobic organic acid is dispersed into an aqueous solution containing a hydroxylamine compound; and
(2) the pH is adjusted to slightly less than 7 by controlling the addition of the hydrophobic organic acid.

In a further exemplary method of forming a desired encapsulating material, the method may comprise using by-product waste alkyl acids to form the hydrophobic organic acid neutralized with an alpha-hydroxyamine compound. In this embodiment, the hydrophobic organic acid neutralized with an alpha-hydroxyamine compound may be formed using the following exemplary steps:
(1) long chain fatty acids (e.g., having from 12 to 24 carbon atoms) are isolated from natural fatty glycerides; and
(2) the long chain fatty acids are neutralized with a hydroxylamine compound.

In one embodiment of the present invention, the step of dispersing the plurality of encapsulated nanoparticles in the stabilizing agent may comprise incorporating the encapsulated nanoparticles in a reaction solution containing acrylamide monomers, methacrylamide monomers, or a combination thereof, and polymerizing the monomers to form a linear polyacrylamide matrix containing the encapsulated nanoparticles. The resulting linear polyacrylamide matrix acts as the stabilizing agent.

In a further embodiment of the present invention, the step of stabilizing encapsulated nanoparticles in a stabilizing agent comprises incorporating the encapsulated nanoparticles in an aqueous solution containing a stabilizing agent, such as a linear polyacrylamide, wherein the aqueous solution containing a solution polymerized linear polyacrylamide acts as the stabilizing agent.

### III. Methods of Using the Compositions

The present invention is further directed to methods of using the above-described compositions and/or composition components (e.g., encapsulated nanoparticles and stabilized encapsulated nanoparticles) in a variety of applications. Any of the above-described compositions and/or composition components (e.g., encapsulated nanoparticles and stabilized encapsulated nanoparticles) may be used as is or may be combined with other materials to form solid or liquid compositions for a variety of applications.

The above-described compositions and/or composition components of the present invention may be used in a variety of applications including, but not limited to, filament warp sizing applications in package dyeing processes; applications for stabilizing a silica formulation in a water/oil emulsion; applications for foaming or spraying compositions onto a fiber or yam; applications for forming a stabilized silica formulation in a water/oil emulsion for application onto a fiber or yarn via a kiss roll; applications for the formation of textile size compositions; applications for the formation of blends containing solid wax particles of the present invention; applications for preparing sized fibers by applying the above-described compositions alone or in combination with any conventional film former onto a fiber at a reduced add-on level; applications for applying the above-described compositions as a spin finish for yarns; applications for spraying or foaming the above-described compositions onto nonwoven fabrics, such as needle-punched nonwoven fabrics to enhance fiber-to-fiber friction; applications for obtaining high fiber cohesion in silicone-treated fibers for dry-laid nonwoven interlinings; applications for coating spun yarn via a kiss roll; applications for coating a filament yarn via a kiss roll; applications to enable manufacture of elastomeric woven fabrics having stretch in both the warp and fill directions; applications for applying the above-described compositions onto a cotton web during a cotton web feeding process prior to a spinning process; applications to reduce yarn hairiness compared to standard yarn sizing compositions; and applications for use in PVA recycle sizing applications.

One desired method of using the compositions of the present invention is in the textile industry. Any of the above-described compositions and/or composition components of the present invention may be applied to a variety of substrates using conventional application techniques. Suitable substrates include, but are not limited to, a fiber, a yarn, a fiber bundle, a warp of fibers or yarns, a nonwoven fabric, such as a dry-laid nonwoven fabric, a woven fabric, a spun yarn, an elastomeric woven fabric, or any other substrate.

The compositions of the present invention may be applied to a given substrate by any conventional process. Suitable application processes include, but are not limited to, spraying the composition onto a substrate, dip coating the composition onto a substrate, kiss roll coating the composition onto a substrate, foam coating the composition onto a substrate, printing the composition onto a substrate, etc.

Any of the above-described compositions and/or composition components (e.g., encapsulated nanoparticles and stabilized encapsulated nanoparticles) are particularly useful as one or more of the following: a component in a warp sizing composition, a component of a final rinse for a package dyeing operation, a component in a prewet foam sizing operation, and a component for a spun yarn sizing composition. When used in these applications, the above-described compositions and/or composition components (e.g., encapsulated nanoparticles and stabilized encapsulated nanoparticles) are typically present in an amount of up to about 2.5 wt %, more desirably, from about 1.0 to about 1.5 wt %, based on a total weight of the sizing composition or final rinse composition based on dyed yarn.

When used as a component for a spun yarn sizing composition, the above-described compositions and/or composition components (e.g., encapsulated nanoparticles and stabilized encapsulated nanoparticles) of the present invention improve the fiber-to-fiber cohesion in the yarn bundle, improve the low end tensile strength of the yarn bundle, improve the low end elongation of the yarn bundle, reduces both warp and filling stops during weaving, and reduces fiber loss during fabric formation. Improvements of both low end tensile strength and low end elongation of the yarn bundle may be as much as 15 to 20% greater than conventional sizing compositions without the above-described compositions and/or composition components (e.g., encapsulated nanoparticles and stabilized encapsulated nanoparticles) of the present invention.

When used as a component for a warp sizing composition, the above-described compositions and/or composition components (e.g., encapsulated nanoparticles and stabilized encapsulated nanoparticles) of the present invention dramatically improve weaving efficiency. For example, when weaving terry toweling comprising a pile yarn of 60 wt % 18s cotton and 40 wt % rayon, weaving efficiency on a Dornier air jet loom increased from about 68% to about 92%. In another example, when weaving denim fabric comprising 100 wt % cotton yarn (8s and 6s), weaving efficiency on a Tseudacoma air jet loom increased from about 88% to about 92.4%. In addition, a dramatic reduction of fiber fly in the weave room was realized.

In one exemplary embodiment of the present invention, the above-described stabilized encapsulated nanoparticles of the present invention are incorporated into a water-based, polymeric sizing system. Suitable water-based, polymeric sizing systems include, but are not limited to, polyester size compositions, sulfonated or carboxylated polyester size compositions, polyacrylate size compositions, or a combination thereof. In this embodiment, the stabilized encapsulated nanoparticles are desirably (i) silica nanoparticles completely encapsulated with (ii) a coating of polyester, and then combined with (iii) a stabilizing agent comprising a polyacrylamide or an aqueous solution containing polyacrylamide. However, other stabilized encapsulated nanoparticles of the present invention may be incorporated into the water-based, polymeric sizing system.

The stabilized encapsulated nanoparticles of the present invention may be incorporated into any of the above-described water-based, polymeric sizing systems in an amount so as to provide one or more desirable features to the resulting size composition. Typically, the stabilized encapsulated nanoparticles of the present invention are incorporated into a water-based, polymeric sizing system in an amount of up to about 20.0 wt % solids of stabilized encapsulated nanoparticles based on a total weight of solids in the resulting size composition. The stabilized encapsulated nanoparticles of the present invention are desirably incorporated into a water-based, polymeric sizing system in an amount of up to about 10.0 wt % solids of stabilized encapsulated nanoparticles, more desirably, from about 2.0 to about 10.0 wt % solids of stabilized encapsulated nanoparticles based on a total weight of solids in the resulting size composition.

In one desired embodiment of the present invention, the resulting size composition (i.e., stabilized encapsulated nanoparticles in a water-based, polymeric sizing system) is applied to a textile fiber via a foam coating process wherein a foamed size composition contacts the textile fiber.

The present invention is further illustrated by the following examples, which are not to be construed in any way as imposing limitations upon the scope thereof. On the contrary, it is to be clearly understood that resort may be had to various other embodiments, modifications, and equivalents thereof, which, after reading the description herein, may suggest themselves to those skilled in the art without departing from the spirit of the present invention and/or the scope of the appended claims.

### EXAMPLES

The materials shown in Table 1 are used in the examples below.

TABLE 1
Chemicals Used In Examples

| Material | Description | Manufacturer |
|---|---|---|
| Nanoparticles | | |
| NYACOL ® | silica nanoparticles | Eka Nobel |
| | having a particle | Marietta, GA |
| | diameter of 20 nm | |
| Encapsulating | | |
| Materials | | |
| PT-125 | polyester resin | Polytech Inc. |
| | dispersion | Greer, SC |
| ethanolamine | hydroxylamine | Dow Chemical Company |
| | | Midland, MI |
| isopropanolamine | hydroxylamine | Dow Chemical Company |
| | | Midland, MI |
| octanoic | hydrophobic acid | Oxford Chemicals Ltd. |
| (caprylic) acid | | Hartlepool UK |
| C¹⁴ to C¹⁸, | hydrophobic acid | any source |
| saturated and | | |
| unsaturated fatty | | |
| acids from | | |
| chicken fat | | |
| Stabilizing Agents | | |
| CALLA WAY | polyacrylamide having | Callaway Chemical |
| 4600 | a MW of (<200,000) | Company |
| | | Columbus, GA |
| glycerol | glycerol | Lynx Chemical Group |
| | | (Columbus, GA) |
| Carrier Materials | | |
| NEUSTRENE | wax | Crompton Corp |
| | | Memphis, TN |
| Oil | Oil | Exxon-Mobil |
| | | Houston, TX |
| Emulsifiers | | |
| HYPERMER ™ | nonionic polymer | Uniqema Corporation |
| 1031 | surfactant | New Castle, DE |
| ATLAS ™ | sorbitan monooleate | Uniqema Corporation |
| G-946 | | New Castle, DE |
| SPAN ™ | sorbitan monooleate | Uniqema Corporation |
| 80 | | New Castle, DE |
| Additives | | |
| Urea | Urea | Mallinckrodt Chemicals |
| | | Phillipsburg, NJ |

### Example 1

### Preparation of Encapsulated Nanoparticles

A polymer encapsulated colloidal metal oxide particle solution was prepared by mixing 7 parts of an aqueous dispersion containing 40% 20 nanometer colloidal silica nanoparticles (NYACOL® nanoparticles) with 100 parts of an aqueous dispersion containing 25% solids polyester resin, the resin prepared from isophthalic acid, terephthalic acid, diethylene glycol, and trimellitic anhydride, and neutralized with monoisopropylamine, and having a number average molecular weight of less than 5,000 daltons (PT-125, Polytech Inc., Greenville, S.C.).

Encapsulation was confirmed by heating a sample until the polyester was burned off (600° C. for 2 hrs). The residue was a high-bulk, low-density white powder of substantially individual particles, not agglomerated granules. The resulting product had product stability at room temperature for 5-7 days. Upon exposure to 53° C., the product was stable for about 24-36 hours.

### Example 2

### Preparation of Stabilized Encapsulated Nanoparticles

Stabilized encapsulated nanoparticles were formed using the encapsulated nanoparticles formed in Example 1. The encapsulated nanoparticles were added to a 20 wt % polyacrylamide aqueous solution.

### Example 3

### Preparation of Dispersed Encapsulated Nanoparticles

Dispersed encapsulated nanoparticles were formed using the encapsulated nanoparticles formed in Example 1. The encapsulated nanoparticles were added to a reaction solution containing acrylamide monomers and an initiator. The mixture was polymerized to form a polyacrylamide matrix containing a linear polyacrylamide polymer and the encapsulated nanoparticles. Care was taken to prevent any crosslinking during the polymerization step.

### Example 4

### Preparation of Wax-Containing Solid Particles

The stabilized encapsulated nanoparticles formed in Example 2 were incorporated into a melted wax mixture as described below. 100 parts of a wax, Neustrene (melting point of >60° C.), were heated to >80° C. 6 parts of an emulsifier blend (4 parts HYPERMER™ 1031 and 2 parts ATLAS™ G-946) were added to the melted wax while stirring vigorously with a Hill mixer. Into the mixture was added 100 parts of aqueous-based stabilized encapsulated nanoparticles formed in Example 2 while stirring and maintaining the mixture temperature at >80° C. The wax mixture was mixed under shear for a few minutes, and then cooled to room temperature (about 22° C.). The resulting solid wax product was flaked to form solid particles.

### Example 5

### Preparation of Wax-Containing Solid Particles

Solid particles were formed using the method described in Example 4 except stabilized encapsulated nanoparticles formed in Example 3 were incorporated into the melted wax mixture.

### Example 6

### Preparation of Oil-Containing Compositions

The stabilized encapsulated nanoparticles formed in Example 2 were incorporated into an oil mixture as described below. 100 parts of oil were heated to >80° C. 10 parts of an emulsifier blend (4 parts HYPERMER™ 1031 and 2 parts ATLAS™ G-946) were added to the oil while stirring vigorously with a Hill mixer. Into the mixture was added 100 parts of aqueous-based stabilized encapsulated nanoparticles formed in Example 2 while stirring and maintaining the mixture temperature at >80° C. The oil mixture was mixed under shear for a few minutes, and then cooled to room temperature (about 22° C.). The resulting oil composition was used as is.

### Example 7

### Preparation of A Water-Based Size Composition

A water-based size composition was prepared by combining 10 g of the stabilized encapsulated nanoparticles formed in Example 2 and 90 g of a sulfonated polyester solution.

### Example 8

### Preparation of Encapsulated Nanoparticles Using A Hydrophobic Acid Encapsulating Material

A mixture was prepared by introducing 144 g of octanoic (caprylic) acid into a warm solution containing 61 of ethanolamine. Rapid mixing was maintained for about 5 minutes until a stable dispersion was formed. Additional ethanolamine was added until a pH between 6.9 and 7.0 was achieved.

Encapsulated nanoparticles were formed by mixing 1 part of colloidal silica solids (NYACOL® 2040) with 7 to 9 parts of neutralized acid.

Encapsulation was confirmed by heating a sample until the neutralized acid was burned off (600° C. for 2 hrs). The residue was a high-bulk, low-density white powder of substantially individual particles, not agglomerated granules. The resulting product had product stability at room temperature for 5-7 days. Upon exposure to 53° C., the product was stable for about 24-36 hours.

### Example 9

### Preparation of Stabilized Encapsulated Nanoparticles Using A Polyhydroxyl Compound As The Stabilizing Agent

Stabilized encapsulated nanoparticles were prepared by mixing 50 parts by weight (pbw) of the encapsulated nanoparticles formed in Example 8 with 50 pbw of glycerol. The resulting mixture was tested for stability as described below.

Stability of a given mixture was measured by monitoring viscosity behavior at room temperature and at 45° C. The resulting mixture maintained a mixture viscosity of less than 1000 cps (i) for a period of up to 14 days at 45° C., and (ii) for a period of up to six months at room temperature.

For comparison purposes, a mixture of the encapsulated nanoparticles formed in Example 8 in an aqueous solution without the stabilizing agent formed an irreversible gel (e.g., a crosslinked gel) within 240 hours at 45° C.

### Example 10

### Preparation of Stabilized Encapsulated Nanoparticles Using A Polyhydroxyl Compound As The Stabilizing Agent

Stabilized encapsulated nanoparticles were prepared by mixing 50 parts by weight (pbw) of the encapsulated nanoparticles formed in Example 1 with 50 pbw of glycerol. The resulting mixture was tested for stability as described in Example 9 above. The resulting mixture maintained a mixture viscosity of less than 1000 cps for a period of up to 180 days at room temperature.

For comparison purposes, a mixture of the encapsulated nanoparticles formed in Example 1 in an aqueous solution without the stabilizing agent formed an irreversible gel (e.g., a crosslinked gel) within 240 hours at 45° C.

### Example 11

### Preparation of Encapsulating Material Formed From By-Product Waste Alkyl Acids

An encapsulating material was prepared as follows. 100 grams of waste (e.g., naturally occurring long chain fatty acids, C¹⁴ through C¹⁸, saturated and unsaturated fatty acids from chicken fat) was dissolved in a liquid methyl ester or mineral oil. This mixture was then neutralized with 24.5 grams of monoisopropanolamine.

### Example 12

### Preparation of Encapsulated Nanoparticles

An encapsulated colloidal metal oxide particle solution was prepared by mixing 7 parts of an aqueous dispersion containing 40% 20 nanometer colloidal silica nanoparticles (NYACOL® nanoparticles) with 100 parts of the encapsulating material prepared in Example 11.

Encapsulation was confirmed by heating a sample until the encapsulating agent was burned off (600° C. for 1 hour). The residue was a very fine, nearly invisible white powder of substantially individual particles, not agglomerated granules.

The liquid product had product stability at room temperature for 5-7 days without a stabilizing agent. Upon exposure to 53° C., the product was stable for 24-36 hours.

### Example 13

### Preparation of Stabilized Encapsulated Nanoparticles

The encapsulated nanoparticles prepared in Example 12 were used to prepare a stabilized encapsulated nanoparticle system. 25 grams of encapsulated nanoparticles prepared in Example 12 were added to an aqueous solution comprising about 15 parts water and 60 parts glycerol, and mixed for about 15 minutes.

### Example 14

### Preparation of A Foamable Composition Containing Stabilized Encapsulated Nanoparticles

The stabilized encapsulated nanoparticles prepared in Example 13 were used to prepare a foamable stabilized encapsulated nanoparticle system. 10 grams of a 62% dioctylsulfosuccinate solution was mixed with 1 gram of lauryl alcohol. This mixture was then diluted with water while mixing to form a 100 gram solution of the diluted mixture. 10 grams of the diluted DOSS/lauryl alcohol mixture was combined with 90 grams of the stabilized encapsulated nanoparticles formed in Example 13.

The resulting mixture provided a product that produced a stable foam when applied to a substrate with a minimum amount of added water. The treated substrate required much less energy to dry than with conventional pad applications.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A composition comprising:
(a) nanoparticles;
(b) a first encapsulating material that encapsulates individual nanoparticles to form encapsulated nanoparticles; and
(c) a stabilizing agent, wherein the stabilizing agent reduces a tendency of the encapsulated nanoparticles to conglomerate, said stabilizing agent comprising at least one polyhydroxyl compound.

2. The composition of claim 1, wherein the nanoparticles comprise metal oxide nanoparticles.

3. The composition of claim 2, wherein the metal oxide nanoparticles comprise silica, tin oxide, antimony pentoxide, zinc oxide, zirconium oxide, yittrium oxide, cerium oxide, or a combination thereof.

4. The composition of claim 2, wherein the metal oxide nanoparticles comprise silica nanoparticles.

5. The composition of claim 1, wherein the nanoparticles have an average particle diameter of from about 4 to about 150 nanometers.

6. The composition of claim 1, wherein the first encapsulating material comprises a polyester resin.

7. The composition of claim 6, wherein the polymer resin comprises a polyester resin formed by polymerizing one or more components selected from isophthalic acid, terephthalic acid, phthalic anhydride, hexane dioic acid, maleic acid, maleic anhydride, diethylene glycol and trimellitic anhydride.

8. The composition of claim 6, wherein the polymer resin comprises a polyester resin formed by polymerizing one or more components selected from isophthalic acid, terephthalic acid, diethylene glycol and trimellitic anhydride.

9. The composition of claim 6, wherein the polyester resin is neutralized with an amine-containing material.

10. The composition of claim 9, wherein the amine-containing material comprises monoisopropylamine, N-methylethanolamine, α-hydroxyamines, monoethanol amines, diethanol amines, triethanol amines, or a combination thereof.

11. The composition of claim 1, wherein the first encapsulating material comprises a hydrophobic acid neutralized with a hydroxylamine compound.

12. The composition of claim 11, wherein the hydrophobic acid comprises (i) Group I acids comprising octanoic (caprylic) acid, nonanoic (pelargonic) acid, decanoic (capric) acid, dodecanoic (lauric) acid, myristic acid, palmitic acid, stearic acid, palmitoleic acid, oleic acid, or linoleic acid; (ii) aromatic acids comprising any of the Group I acids substituted with one or more aromatic groups; (iii) alkene/acrylic acid copolymers; and (iv) combinations thereof.

13. The composition of claim 12, wherein the hydroxylamine compound comprises monoisopropylamine, N-methylethanolamine, α-hydroxyamines, monoethanol amines, diethanol amines, triethanol amines, or a combination thereof.

14. The composition of claim 1, wherein the nanoparticles and the first encapsulating material are present at a weight ratio of from about 1:3 to about 1:15 based on total solids of nanoparticles and the first encapsulating material.

15. The composition of claim 4, wherein the silica nanoparticles (i) have an average particle diameter of about 15 to about 20 nanometers, and (ii) are completely encapsulated with a polyester formed by polymerizing one or more components selected from isophthalic acid, terephthalic acid, diethylene glycol and trimellitic anhydride, and neutralized with an α-hydroxyamine; and wherein the silica nanoparticles and the neutralized polyester are present at a weight ratio of from about 1:3 to about 1:15 based on total solids of silica nanoparticles and neutralized polyester.

16. The composition of claim 1, wherein the at least one polyhydroxyl compound comprises glycerol; ethylene glycol; diethylene glycol; one or more monosaccharides; glucose; and combinations thereof.

17. The composition of claim 1, wherein the composition comprises up to about 60 wt % of one or more polyhydroxyl compounds, and up to about 40 wt % of encapsulated nanoparticles, based on a total weight of the composition.

18. The composition of claim 1, wherein the composition comprises:
up to about 60 wt % of one or more polyhydroxyl compounds;
from about 25 wt % to about 30 wt % of encapsulated nanoparticles; and
water and one or more optional additives; wherein all weight percents are based on a total weight of the composition.

19. A composition comprising:
(a) nanoparticles;
(b) a first encapsulating material that encapsulates individual nanoparticles to form encapsulated nanoparticles;
(c) a stabilizing agent, wherein the stabilizing agent reduces a tendency of encapsulated nanoparticles to conglomerate; and
(d) a water-insoluble carrier material encapsulating the stabilizing agent and encapsulated nanoparticles,
wherein a plurality of individual masses of stabilizing agent in combination with encapsulated nanoparticles is distributed within the carrier material.

20. The composition of claim 19, wherein the nanoparticles comprise silica, tin oxide, antimony pentoxide, zinc oxide, zirconium oxide, yittrium oxide, cerium oxide, or a combination thereof.

21. The composition of claim 19, wherein the first encapsulating material comprises (i) a polyester resin neutralized with a hydroxylamine compound or (ii) a hydrophobic acid neutralized with a hydroxylamine compound.

22. The composition of claim 20, wherein the first encapsulating material comprises (i) a polyester resin neutralized with a hydroxylamine compound.

23. The composition of claim 19, wherein the stabilizing agent comprises (i) at least one polyhydroxyl compound or (ii) a linear polyacrylamide polymer or copolymer.

24. The composition of claim 23, wherein the stabilizing agent comprises a linear polyacrylamide polymer or copolymer formed using a solution polymerization procedure.

25. The composition of claim 23, wherein the stabilizing agent and the encapsulated nanoparticles are present at a weight ratio of from about 95:1 to about 1:5 based on total solids of the stabilizing agent and the encapsulated nanoparticles.

26. The composition of claim 23, wherein the stabilizing agent and the encapsulated nanoparticles are present at a weight ratio of from about 15:1 to about 1:3 based on total solids of the stabilizing agent and the encapsulated nanoparticles.

27. The composition of claim 19, wherein:
(a) the nanoparticles comprise silica nanoparticles that are completely encapsulated with a polyester formed by polymerizing one or more components selected from isophthalic acid, terephthalic acid, diethylene glycol and trimellitic anhydride, and neutralized with an α-hydroxyamine;
(b) the silica nanoparticles and the neutralized polyester are present at a weight ratio of from about 1:3 to about 1:15 based on total solids of silica nanoparticles and neutralized polyester;
(c) the stabilizing agent comprises a linear polyacrylamide formed using a solution polymerization procedure; and
(d) the polyacrylamide and the encapsulated nanoparticles are present at a weight ratio of from about 15:1 to about 1:3 based on total solids of polyacrylamide and encapsulated nanoparticles.

28. The composition of claim 19, wherein the water-insoluble carrier material comprises a wax; an oil; an alkyl ester; or a surfactant system containing a fatty acid.

29. The composition of claim 19, wherein the water-insoluble carrier material comprises a wax, said wax comprising a tallow glyceride ester, a hydrogenated tallow glyceride ester, a hydrocarbon-based wax, or a combination thereof.

30. The composition of claim 29, wherein the wax comprises a hydrogenated tallow glyceride ester.

31. The composition of claim 29, wherein the composition further comprises at least one emulsifier.

32. The composition of claim 31, wherein the at least one emulsifier assists in uniformly distributing stabilized encapsulated nanoparticles throughout the wax.

33. The composition of claim 31, wherein the at least one emulsifier comprises a polymeric surfactant, a sorbitan monooleate surfactant, or a mixture thereof.

34. The composition of claim 29, wherein the wax and the stabilized encapsulated nanoparticles are present at a weight ratio of from about 5:1 to about 1:5.

35. The composition of claim 29, wherein:
(a) the nanoparticles comprise silica nanoparticles that are completely encapsulated with a polyester formed by polymerizing one or more components selected from isophthalic acid, terephthalic acid, diethylene glycol and trimellitic anhydride, and neutralized with an α-hydroxyamine;
(b) the silica nanoparticles and the neutralized polyester are present at a weight ratio of from about 1:3 to about 1:15 based on total solids of silica nanoparticles and neutralized polyester;
(c) the stabilizing agent comprises a linear polyacrylamide;
(d) the polyacrylamide and the encapsulated nanoparticles are present at a weight ratio of from about 15:1 to about 1:3 based on total solids of polyacrylamide and encapsulated nanoparticles;
(e) the carrier material comprises a wax selected from the group consisting of a tallow glyceride ester, a hydrogenated tallow glyceride ester, a hydrocarbon-based wax, and combinations thereof;
(f) the composition further comprises a blend of emulsifiers, wherein the blend of emulsifiers comprises about 2 parts by weight (pbw) of a polymeric surfactant and about 1 pbw sorbitan monooleate surfactant;
(g) wherein the wax and the individual masses are present at a weight ratio of from about 5:1 to about 1:5 based on total solids of wax and the individual masses; and
(h) wherein the blend of emulsifiers is present in an amount of up to about 6 parts by weight (pbw) for every 100 pbw of wax.

36. A solid particle comprising the composition of claim 29.

37. The solid particle of claim 36, wherein the solid particle comprise flakes of solid wax-containing material.

38. A mixture of solid particles, wherein the mixture comprises the solid particle of claim 37.

39. The mixture of claim 38, wherein the mixture further comprises solid particles comprising polyvinyl alcohol, starch, carboxymethyl cellulose, urea, other waxes, or a combination thereof.

40. The composition of claim 19, wherein the water-insoluble carrier material comprises an oil.

41. The composition of claim 40, wherein the oil comprises a natural oil, a synthetic oil, or a combination thereof.

42. The composition of claim 40, wherein the oil completely encapsulates the individual masses containing the stabilizing agent and the encapsulated nanoparticles.

43. The composition of claim 40, wherein the composition further comprises at least one emulsifier that assists in uniformly distributing the individual masses throughout the oil.

44. The composition of claim 40, wherein the oil and the individual masses are present at a weight ratio of from about 25:1 to about 1:10.

45. The composition of claim 19, wherein:
(a) the nanoparticles comprise silica nanoparticles that are completely encapsulated with a polyester formed by polymerizing one or more components selected from isophthalic acid, terephthalic acid, diethylene glycol and trimellitic anhydride, and neutralized with an α-hydroxyamine;
(b) the silica nanoparticles and the neutralized polyester are present at a weight ratio of from about 1:3 to about 1:15 based on total solids of silica nanoparticles and neutralized polyester;
(c) the stabilizing agent comprises a linear polyacrylamide;
(d) the polyacrylamide and the encapsulated nanoparticles are present at a weight ratio of from about 15:1 to about 1:2 based on total solids of polyacrylamide and encapsulated nanoparticles;
(e) the carrier material comprises an oil;
(f) the composition further comprises a blend of emulsifiers, wherein the blend of emulsifiers comprises about 2 parts by weight (pbw) of a polymeric surfactant and about 1 pbw sorbitan monooleate surfactant;
(g) wherein the oil and the individual masses are present at a weight ratio of from about 25:1 to about 1:5; and
(h) wherein the blend of emulsifiers is present in an amount of up to about 10 parts by weight (pbw) for every 100 pbw of oil.

46. A textile size composition comprising the composition of claim 1.

47. The textile size composition of claim 46, further comprising starch, polyvinyl alcohol, carboxymethyl cellulose, or a combination thereof.

48. A substrate having on a surface thereof the composition of claim 1.

49. The substrate of claim 48, wherein the substrate is a fiber; a yarn; a fiber bundle; a warp; a nonwoven fabric; a woven fabric; a spun yarn; or an elastomeric woven fabric.

50. A textile size composition comprising the composition of claim 19.

51. The textile size composition of claim 50, further comprising starch, polyvinyl alcohol, carboxymethyl cellulose, or a combination thereof.

52. A substrate having on a surface thereof the composition of claim 19.

53. The substrate of claim 52, wherein the substrate is a fiber; a yarn; a fiber bundle; a warp; a nonwoven fabric; a woven fabric; a spun yarn; or an elastomeric woven fabric.

54 A method for forming a coated substrate, said method comprising the steps of:
applying the composition of claim 1 onto the substrate.

55 A method for forming a coated substrate, said method comprising the steps of:
applying the composition of claim 19 onto the substrate.

56. A method for making a composition, said method comprising the steps of:
stabilizing a plurality of encapsulated nanoparticles by combining the plurality of encapsulated nanoparticles with a stabilizing agent that reduces a tendency of the encapsulated nanoparticles to conglomerate with one another, said stabilizing agent comprising at least one polyhydroxyl compound.

57. A method for making a composition, said method comprising the steps of:
forming a mixture of individual masses of stabilized encapsulated nanoparticles distributed within a water-insoluble carrier material, wherein the water-insoluble carrier material comprises a wax; an oil; an alkyl ester; or a surfactant system containing a fatty acid.
